(19) United States
(12) Patent Application Publication
(10) Pub. No.: US 2026/0064557 A1
(43) Pub. Date: Mar. 5, 2026

(54) NETWORK TRAFFIC MANAGEMENT

(71) Applicant: Kantar UK Limited, London (GB)

(72) Inventors: Raguram Kamakshisundaram, Darien, CT (US); Robert Katz, New York, NY (US); Normand Thomas Morneau, Chicago, IL (US); Steven Jay Silvers, Avon, CO (US); Jonathan Matthew Blau, Morristown, NJ (US)

(73) Assignee: Kantar UK Limited, London (GB)

(21) Appl. No.: 19/306,724

(22) Filed: Aug. 21, 2025

Related U.S. Application Data
(60) Provisional application No. 63/687,581, filed on Aug. 27, 2024.

(51) Int. Cl. G06F 11/34; G06F 21/57

(52) U.S. Cl. CPC G06F 11/3428; G06F 21/57

(57) ABSTRACT

A system to manage network traffic is described. The system can include a data processing system that receives a request to execute a data analysis process to measure an effectiveness of a first content item on a plurality of end user computing devices. Client data, for each end user computing device, can be accessed, which includes interaction data representing interactions with the first content item. A data processing model can be executed in a secure environment using the client data to obtain (i) transformed client data structured in accordance with a predefined format and (ii) a data mapping of one or more data fields from the client data to input data. A performance score representing the effectiveness can be received from the external computing device based on (i) the transformed client data and (ii) the data mapping. A second content item can be selected based on the performance score.

### CROSS-REFERENCE TO RELATED APPLICATION

This application claims the benefit of priority of U.S. Provisional Patent Application No. 63/687,581, filed Aug. 27, 2024. The contents of this provisional application are incorporated herein by reference in its entirety.

### BACKGROUND

Computing devices communicate by exchanging data. This data can be exchanged using communications networks, like the Internet. More data exchanges can result in more traffic across the communications networks.

### SUMMARY

At least one aspect of the present disclosure is directed to a system to manage network traffic. The system can include a data processing system including one or more processors, coupled with memory. The data processing system can receive, from a client computing device, a request to execute a data analysis process to measure an effectiveness of a first content item on a plurality of end user computing devices. The client data can be accessed, which includes, for each of the plurality of end user computing devices, interaction data representing interactions with the first content item. Using the client data, a data processing model can be executed in a secure environment to obtain (i) transformed client data structured in accordance with a predefined format and (ii) a data mapping of one or more data fields from the client data to input data. A performance score representing the effectiveness of the first content item can be received from a computing device external to the secure environment. The performance score can be based on (i) the transformed client data structured in accordance with the predefined format and (ii) the data mapping of the one or more data fields from the client data to the input data. A second content item can be selected based on the performance score.

At least one aspect of the present disclosure is directed to a method. The method can include receiving, from a client computing device, a request to execute a data analysis process to measure an effectiveness of a first content item on a plurality of end user computing devices. The method can include accessing client data, which includes, for each of the plurality of end user computing devices, interaction data representing interactions with the first content item. The method can include executing a data processing model in a secure environment to use the client data to obtain (i) transformed client data structured in accordance with a predefined format and (ii) a data mapping of one or more data fields from the client data to input data. The method includes receiving, from a computing device external to the secure environment, a performance score representing the effectiveness of the first content item based on (i) the transformed client data structured in accordance with the predefined format and (ii) the data mapping of the one or more data fields from the client data to the input data. The method can include selecting a second content item based on the performance score.

At least one aspect of the present disclosure is directed to one or more storage medium that store instructions thereon, that, when executed by one or more processors, cause the one or more processors to receive, from a client computing device, a request to execute a data analysis process to measure an effectiveness of a first content item on a plurality of end user computing devices. The instructions can cause the one or more processors to access client data including, for each of the plurality of end user computing devices, interaction data representing interactions with the first content item. The instructions can cause the one or more processors to execute, using the client data, a data processing model in a secure environment to obtain (i) transformed client data structured in accordance with a predefined format and (ii) a data mapping of one or more data fields from the client data to input data. The instructions can cause the one or more processors to receive a performance score representing the effectiveness of the first content item from a computing device external to the secure environment, and the performance score can be based on (i) the transformed client data structured in accordance with the predefined format and (ii) the data mapping of the one or more data fields from the client data to the input data. The instructions can cause the one or more processors to select a second content item based on the performance score.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example system to manage network traffic.

FIG. 2 is an example method of managing network traffic.

FIG. 3 is an example computing architecture of a data processing system.

### DETAILED DESCRIPTION

Following below are more detailed descriptions of various concepts related to, and implementations of, methods, apparatuses, programming, and systems to manage network traffic. In particular, the systems, methods, and programming described herein manage data exchanges across a network to reduce secure data exposure to unauthorized computing devices. The various concepts introduced above and discussed in greater detail below may be implemented in any of numerous ways.

As the volume and type of currently available content items continues to increase, new techniques are needed to determine, amongst other factors, which content items are relevant, what computing devices are to be provided with some or all of those relevant content items, and when those selected content items are going to be provided to the selected computing devices. However, systems that perform the aforementioned-mentioned determination face technical challenges: (i) measure the performance of the provided content items with the results being unverifiable or (ii) expose secure data, such as proprietary data, client data, etc., to external computing devices that provide verifiable measures of the performance of the content items.

Techniques to measure the performance of content items can include leveraging third-party systems. These third-party systems are often used because they have verifiable solutions (e.g., solutions that comply with privacy regulations and guidelines). Additionally, these third-party systems are selected because of the quality of the results they produce. While this addresses the first technical problem of providing verifiable results, the second technical problem of exposing secure data remains. Further compounding matters is that this second technical problem results in additional technical problems, such as increased data traffic with those third-party systems (e.g., increased application programming interface (API) calls with the third-party system's computing device), increased latency in producing or obtaining results, and increased computational cost required to execute all of the increased data exchanges with the third-party system (all of which cause exposure of the secure data). As a result of these limitations, third-party systems may have reduced data availability because of privacy limitations, tracking limitations, or require user consent before sharing data, amongst other issues, all of which can increase the processing time to compute the performance score and use that knowledge for further downstream tasks (e.g., updating resource allocation schemas, identifying other content items to be provided to end user computing devices, etc.). This results in still more technical problems, such as a longer setup time for each measurement, increased computational operations for data transferring, increased time to execute data processing tasks, and inconsistent costs due to different fee schedules for each third-party system.

To solve these, and other technical issues, the technical solution provided herein can include a software application that is able to access client data in a secure environment. The client data can include interaction data representing interactions of end user computing devices with content items. The secure environment can include logic to format client data to be input to a computing device external to the secure environment that determines a performance score of the content items. The performance score can then be provided to a computing device deploying the secure environment to determine a different, additional, or alternative, type of content item or items to be provided to some or all of the end user computing devices. As a result of this solution, the verifiable performance scores can be obtained and be used to manage network traffic to reduce data exchange with the computing device external to the secure environment. This results in reduced network traffic. Moreover, the use by the data processing system of the performance score to select content items enhances security and efficiency by minimizing unnecessary data exchange between systems, thereby obtaining verifiable performance scores with reduced network traffic. For example, by executing a data processing model in a secure environment to transform client data into a predefined format (e.g., for external devices), the solution can safeguard sensitive or additional information that would otherwise be exposed. In addition to enhancing security and reducing data exchanges, the solution can improve response times and reduce computational costs by selecting a content item based on a performance score representing an effectiveness of a previously provided content item.

The secure environment can ensure that only authorized computing devices can access the client data. The secure environment can include logic to transform the client data to be transformed into client data. The transformed client data can have a predefined format. For example, the predefined format can correspond to a format of input data by the computing device external to the secure environment to determine the performance score. As opposed to sending the client data (e.g., representing the interactions of the end user computing devices) to the computing device external to the secure environment to be processed and subsequently used to generate a performance score, a representation of that client data can be provided to the computing device external to the secure environment. The representation can be a transformed version of the client data. For example, an aggregated version of the client data can be exposed to the computing device external to the secure environment. By providing the representation (e.g., transformed client data) instead of the client data, only the representation can be exposed during data exchanges as opposed to the client data. As the representation itself is a transformation of the client data, even if a malicious entity could otherwise obtain access to the representation, the malicious entity would need to know the transformation(s) performed to the client data in order to derive the client data from the transformed client data.

The secure environment has additional technical advantages in that it is not limited by the types of client data that can be analyzed. For example, data that otherwise consumes more computing resources can be used as a basis when the performance score is being computed because that data does not need to be transmitted out of the secure environment. Still further, because the client data is accessible via the secure environment, it can be available quickly for processing (it no longer needs to be sent out to a third-party computing device) and may not incur as high a data transfer cost or processing cost.

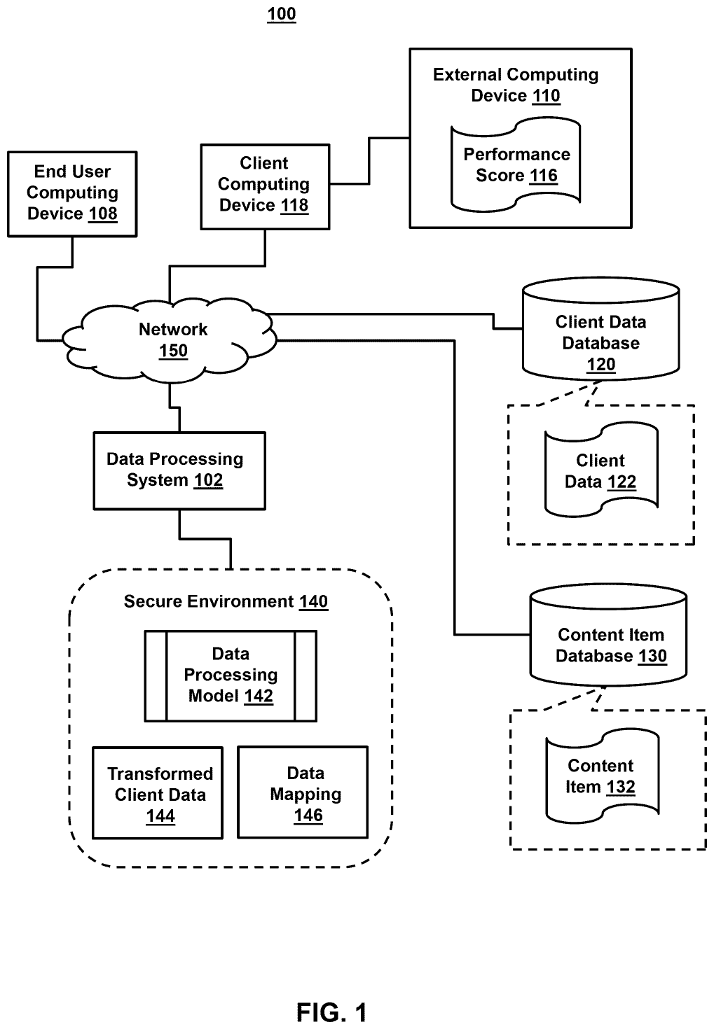

Referring to FIG. 1, among others, a system 100 is described that manages network traffic. System 100 can be a group, collection, or network of apparatus, devices, systems, or platforms. System 100 can include at least one data processing system, such as a data processing system 102. Data processing system 102 can include at least one computer, computing device, computing system, server, server farm, server network, or any other centralized or distributed processing system or environment. Data processing system 102 can be coupled with at least one client computing device, such as a client computing device 118, at least one external computing device, such as external computing device 110, at least one end user computing device, such as an end user computing device 108, or one or more databases, such as client data database 120 and content item database 130, or with other components, or combinations thereof.

Data processing system 102, end user computing device 108, external computing device 110, and client computing device 118 can communicate over at least one network, such as a network 150. Network 150 can be or include the Internet, a Wide Area Network (WAN), a Local Area Network (LAN), a Wi-Fi network, a cellular network (e.g., a 3G network, a 4G network, or a 5G network). Network 150 can be or include a wired or wireless network. Network 150 can include modems, routers, network switches, cell towers, network repeaters, and antennae.

System 100 can include a separate content publisher or publisher platform to deliver, provide, or transmit content items (e.g., digital content) to end user computing device 108. For example, the content publisher/publisher platform can generate and provide digital content, such as content item 132, to content item database 130. Content item database 130 can store content one or more content items including content item 132. For example, content item database 130 can store a first content item and a second content item.

Client data database 120 can store client data 122. Client data 122 can include interaction data representing one or more interactions of end user computing device 108 with a content item, such as content item 132. For example, data processing system 102 can provide a first content item to end user computing device 108. Data processing system 102 can track, monitor, and store interactions of end user computing device 108 within a first amount of time before the first content item is delivered and within a second amount of time after the first content item is delivered as client data 122. Client data 122 can include interaction data associated with one or more end user computing devices, such as end user computing device 108. For example, client data 122 can include interaction data representing interactions of a first end user computing device with the first content item and interaction data representing interactions of a second end user computing device with the first content item.

Client data database 120, content item database 130, or other databases or data repositories used within system 100 can also include a data storage system, a data lake, a very large database (VLDB), a relational database, a structured query language (SQL) database, a not only SQL (NoSQL) database, or a graph database, amongst others. Data processing system 102 can receive, collect, or aggregate client data 122 and store client data 122 in client data database 120. Data processing system 102 can collect client data 122 from end user computing devices, such as end user computing device 108. Data processing system 102 can, alternatively or additionally, obtain client data 122 from client computing device 118, or from other devices. For example, data processing system 102 can determine interactions detected by end user computing device 108 in response to a first content item (e.g., content item 132) being provided to end user computing device 108. As illustrative examples, the interactions can include keystrokes, taps, clicks, scrolls, dwell time, browser activity, and the like. The first amount of time (i.e., before the first content item has been delivered) can be one or more seconds, one or more minutes, one or more hours, or other amounts of time. Similarly, the second amount of time (i.e., after the first content it has been delivered) can be one or more seconds, one or more minutes, one or more hours, or other amounts of time. The first amount of time can be the same, or substantially similar to the second amount of time. However, in other cases, the first amount of time and the second amount of time can be different.

Data processing system 102 can select and provide one or more of content items, such as content item 132, to one or more end user computing devices, such as end user computing device 108. As an example, the content items stored in content item database 130, or other databases, or combinations thereof, can be generated as part of a campaign where one or multiple different content items are provided to one or more end user computing devices. Content item 132 can include at least one image, at least one link, at least one video, audio, or other data that can be accessed by data processing system 102. For instance, content item 132 can be displayed on a display device of/coupled to end user computing device 108, can be a video to play on the display device, audio to play on a speaker of/coupled to one or more of end user computing device 108, or other data. End user computing device 108 or client computing device 118 can be smartphones, laptop computers, desktop computers, set-top boxes, smart televisions, tablets, smart watches, or augmented or virtual reality headsets.

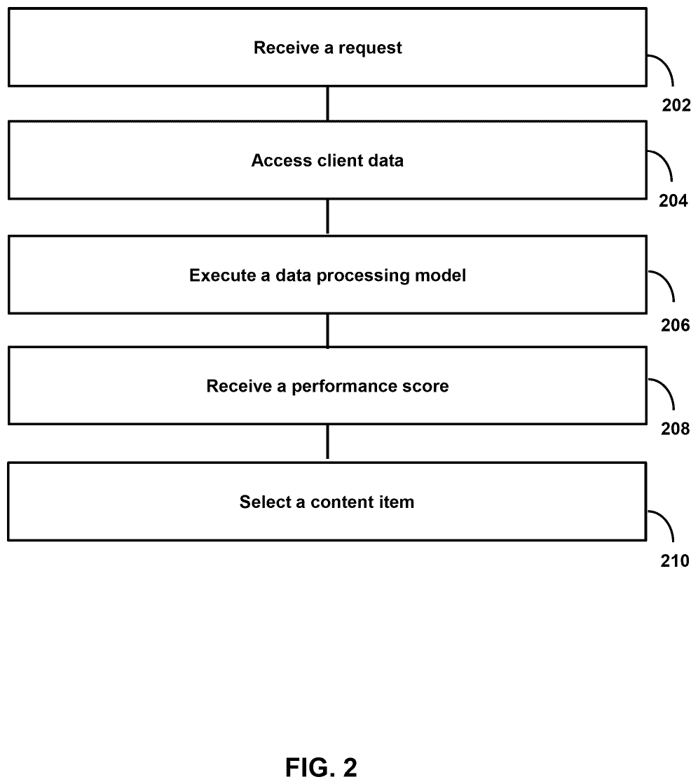

FIG. 2 is an example method 200 of managing network traffic. Data processing system 102, end user computing device 108, external computing device 110, and client computing device 118, and other elements can perform at least a portion of the method 200. Method 200 can include additional acts, fewer acts, or alternative acts. Furthermore, an order of operations of method 200 can vary, and the presented order is one implementation amongst others.

Method 200 can include receiving, from client computing device 118, a request. The request can include a request to execute a data analysis process. The request can be received by data processing system 102. The data analysis process can measure an effectiveness of a first content item (e.g., content item 132) on a plurality of end user computing devices (e.g., one or more instances of end user computing device 108) (ACT 202). The effectiveness of the first content item based on the interactions detected by the end user computing devices just before and just after the first content item is provided. For example, data processing system 102 can detect the interactions indicating that an operator of end user computing device 108 interacted with the first content item after being displayed (using the end user computing device or a display device coupled thereto). As another example, the interactions can indicate that an operator of end user computing device 108 did not interact with the first content item within a given amount of time of the first content item being provided and displayed. The measure of the effectiveness can be computed by an external computing device, such as external computing device 110. The measure of the effectiveness can be computed by data processing system 102.

Data processing system 102 can retrieve the first content item from content item database 130. For example, content item 132 can include a first content item and a second content item. A quantity of content items stored in content item database 130 can include 10² or more content items, 10³ or more content items, 10⁶ or more content items, 10⁹ or more content items, or more, for example.

Each end user computing device, such as end user computing device 108, can be selected from a corpus of candidate end user computing devices based on end user information associated with each candidate end user computing device 108. Data processing system 102 can select the end user computing devices. Client computing device 118 can select the end user computing devices. In some cases, client computing device 118 and data processing system 102 can determine the end user computing devices to be selected. For example, certain end user computing devices can correspond to an end user having first end user parameter (e.g., device type of end user computing device 108, an operating system of end user computing device 108, frequency of use of end user computing device 108, etc.), while other end user computing device 108 can correspond to an end user having a second end user parameter (e.g., device type of end user computing device 108, an operating system of end user computing device 108, frequency of use of end user computing device 108, etc.). Data processing system 102 can select the first content item (e.g., content item 132) based on, amongst others, the end user information associated with each candidate end user computing device. Client computing device 118 can select the first content item (e.g., content item 132) based on, amongst others, the end user information associated with each candidate end user computing device. Data processing system 102 and client computing device 118 can determine the first content item (e.g., content item 132) to be selected based on, amongst others, the end user information associated with each candidate end user computing device.

Method 200 can include accessing client data. (ACT 204). For example, data processing system 102 can access client data 122 for each end user computing device, such as end user computing device 108. Client data 122 can include interaction data. The interaction data can represent interactions with the first content item. Data processing system 102 can access client data 122 from client data database 120.

As mentioned above, client data 122 can include interaction data. The interaction data can represent interactions detected by each end user computing device 108 with the first content item (e.g., content item 132). These interactions can include interactions detected by end user computing device 108 within a first amount of time prior to receipt of the first content item (e.g., content item 132). The interactions can also include interactions detected by end user computing device 108 within a second amount of time after the receipt of the first content item (e.g., content item 132). The first amount of time (i.e., before the first content item has been delivered) can be one or more seconds, one or more minutes, one or more hours, or other amounts of time. The second amount of time (i.e., after the first content item has been delivered) can be one or more seconds, one or more minutes, one or more hours, or other amounts of time. The first amount of time and the second amount of time can be adjusted by data processing system 102 and can differ from one another.

To access client data 122, data processing system 102 can authorize, based on the request, access to a data repository that securely stores client data 122. For example, an application programming interface (API) can allow data processing system 102 to access client data database 120 to retrieve client data 122. Data processing system 102 can provide client data 122 with access to secure environment 140 to execute the data analysis process. In some examples, data can be exchanged between data processing system 102 and secure environment 140 using RESTful APIs. GraphQL, Functions, Data Shares, Message Queues, or other data exchanges mechanisms, or combinations thereof.

Method 200 can include executing a data processing model. (ACT 206). For example, method 200 can include executing, using client data 122, a data processing model 142. Data processing system 102 can execute data processing model 142 in secure environment 140. Execution of data processing model 142 can cause data processing system 102 to obtain (i) transformed client data 144 and (ii) a data mapping. Transformed client data 144 can be structured in accordance with a predefined format. Data mapping 146 can map one or more data fields from client data 122 to input data.

Secure environment 140 can prevent exposure of client data 122 to unauthorized computing devices. As an example, secure environment 140 can include a containerized application. A containerized application refers to an application run via containers (i.e., isolated code packages). Containers do not require a host operating system and are isolated from other applications and components of data processing system 102.

Data processing system 102 can generate data processing model 142 based on input received from client computing device 118 and the first content item (e.g., content item 132). Data processing system 102 can deploy a client application that includes software to implement data processing model 142. The client application can instantiate secure environment 140. In some examples, the client application can be deployed using one or more ephemeral computing resources.

Secure environment 140 can store logic to transform client data 122 into transformed client data 144. Transformed client data 144 can be formatted so that it can serve as input data for external computing device 110 to generate performance score 116. For example, external computing device 110, which can exist external to secure environment 140, can execute one or more models, algorithms, or processes to generate performance score 116. However, the format of the input data used by external computing device 110 to generate performance score 116 can differ from that of client data 122. Data processing model 142 can generate transformed client data 144 based on client data 122 and the first content item (e.g., content item 132) provided to end user computing device 108. For example, different types of content items can indicate the particular transformations to be executed by data processing model 142.

Secure environment 140 can store logic to generate data mapping 146. For example, data processing model 142 can generate data mapping 146 and transformed client data 144. Alternatively, a separate data processing model can be used to generate data mapping 146. Data mapping 146 indicates one or more relationships between transformed client data 144 (as well as, in some examples, client data 122) and the input data used by external computing device 110 to generate performance score 116. For example, data mapping 146 may indicate that data from transformed client data 144 maps to an input data field of the input data for external computing device 110 to generate performance score 116.

Data processing system 102 can provide (i) transformed client data 144 and (ii) data mapping 146 to external computing device 110. The predefined format of transformed client data 144 can correspond to a format of input data to external computing device 110 so that external computing device 110 can compute performance score 116. For example, the predefined format can indicate a size of the input data, a programming language, using pre-defined labels, or other characteristics of the input data for external computing device 110 to generate performance score 116.

Method 200 can include receiving performance score 116 (ACT 208). For example, method 200 can include data processing system 102 receiving performance score 116. Performance score 116 can represent the effectiveness of the first content item. Performance score 116 can be generated by external computing device 110. For example, external computing device 110 can generate performance score 116 based, amongst other aspects, on (i) transformed client data 144 and (ii) data mapping 146. Transformed client data 144 can be structured in accordance with the predefined format. For example, the predefined format can include a format of the input data used by external computing device 110 to generate performance score 116. Data mapping 146 can map (i.e., indicate relationships) data fields from client data 122 to the input data.

Data processing system 102 can execute an encryption process. The encryption process can transform client data 144 and data mapping 146 to generate encrypted client data and an encrypted data mapping. For example, data processing system 102 can salt, hash, or salt and hash transformed client data 144 and data mapping 146. The encrypted client data and the encrypted data mapping can be provided to external computing device 110 to determine performance score 116. For example, external computing device 110 can store a decryption process to decrypt the encrypted client data and the encrypted data mapping. Furthermore, external computing device 110 can store an encryption process to encrypt performance score 116 prior to being provided to data processing system 102. Data processing system 102 can receive the encrypted performance score and can decrypt the encrypted performance score using a decryption process to obtain performance score 116. The encryption process and the decryption process can be implemented using one or more encryption/decryption algorithms (e.g., symmetric encryption, asymmetric encryption, RSA, etc.).

Method 200 can include selecting a content item (ACT 210). Data processing system 102, for example, can select a second content item (e.g., content item 132) based on performance score 116. Data processing system 102 can select the second content item, such that it is different from the first content item with which performance score 116 was computed. Data processing system 102 can provide the second content item to at least a subset of end user computing devices, such as end user computing device 108. For example, based on performance score 116, data processing system 102 can select a content item (e.g., content item 132), select one or more instances of end user computing device 108, and provide the selected content item to the one or more selected end user computing device 108.

Data processing system can select and provide the first content item (e.g., content item 132) to end user computing device 108 based on a resource allocation schema. The resource allocation schema can indicate how different resources are to be allocated to end user computing device 108. For example, the resources that can be allocated can include computing resources, content items, network coverage, and the like. As mentioned above, the first content item (e.g., content item 132) can be selected based on a first resource allocation schema. The first resource allocation schema may indicate that, based on previous performance scores computed based on prior interactions associated with a different content item previously provided to some or all of end user computing devices. Data processing system 102 can generate a second resource allocation schema including an updated allocation of the resources to the end user computing devices based on performance score 116.

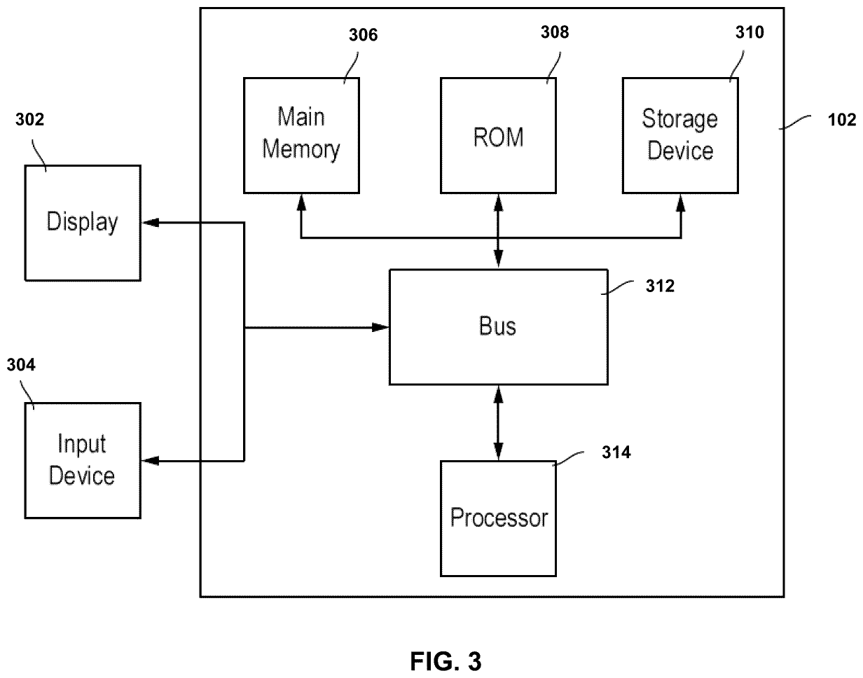

Referring to FIG. 3, among others, an example block diagram of data processing system 102 is shown. Data processing system 102 can include or be used to implement a data processing system or its components. The architecture described in FIG. 3 can be used to implement data processing system 102, end user computing device 108, external computing device 110, client computing device 118, or other components of system 100. Data processing system 102 can include at least one bus 312 or other communication component for communicating information and at least one processor 314 or processing circuit coupled to bus 312 for processing information. Data processing system 102 can include one or more processors 314 or processing circuits coupled to bus 312 for processing information. Data processing system 102 can include at least one main memory 306, such as a random access memory (RAM) or other dynamic storage device, coupled to bus 312 for storing information, and instructions to be executed by processor 314. The main memory 306 can be used for storing information during execution of instructions by processor 314. Data processing system 102 can further include at least one read only memory (ROM) 308 or other static storage device coupled to bus 312 for storing static information and instructions for processor 314. A storage device 310, such as a solid state device, magnetic disk or optical disk, can be coupled to bus 312 to persistently store information and instructions.

Data processing system 102 can be coupled via bus 312 to a display 302, such as a liquid crystal display, or active matrix display. Display 302 can display information to a user. An input device 304, such as a keyboard or voice interface can be coupled to bus 312 for communicating information and commands to processor 314. Input device 304 can include a touch screen of display 302. Input device 304 can include a cursor control, such as a mouse, a trackball, or cursor direction keys, for communicating direction information and command selections to processor 314 and for controlling cursor movement on display 302.

The processes, systems and methods described herein can be implemented by data processing system 102 in response to processor 314 executing an arrangement of instructions contained in main memory 306. Such instructions can be read into main memory 306 from another computer-readable medium, such as the storage device 310. Execution of the arrangement of instructions contained in main memory 306 causes data processing system 102 to perform the illustrative processes described herein. One or more processors in a multi-processing arrangement can be employed to execute the instructions contained in main memory 306. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

1. A system to manage network traffic, comprising:
a data processing system comprising one or more processors, coupled with memory, to:
receive, from a client computing device, a request to execute a data analysis process to measure an effectiveness of a first content item on a plurality of end user computing devices;
access client data comprising, for each of the plurality of end user computing devices, interaction data representing interactions with the first content item;
execute, using the client data, a data processing model in a secure environment to obtain (i) transformed client data structured in accordance with a predefined format and (ii) a data mapping of one or more data fields from the client data to input data;
receive, from a computing device external to the secure environment, a performance score representing the effectiveness of the first content item based on (i) the transformed client data structured in accordance with the predefined format and (ii) the data mapping of the one or more data fields from the client data to the input data; and
select a second content item based on the performance score.

2. The system of claim 1, wherein the data processing system comprises the one or more processors, coupled with the memory to:
provide, to the computing device external to the secure environment, (i) the transformed client data structured in accordance with the predefined format and (ii) the data mapping of the one or more data fields from the client data to the input data.

3. The system of claim 1, wherein the predefined format corresponds to a format of input data to the computing device external to the secure environment to compute the performance score.

4. The system of claim 1, wherein the secure environment prevents exposure of the client data.

5. The system of claim 1, wherein the secure environment stores logic for transforming the client data into input data for the computing device external to the secure environment to generate the performance score.

6. The system of claim 1, wherein the data processing system comprising the one or more processors, coupled with the memory to:
provide the second content item to at least a subset of the plurality of end user computing devices.

7. The system of claim 1, wherein the interaction data representing interactions with the first content item comprises (i) interactions detected by the plurality of end user computing devices within a first amount of time prior to receipt of the first content item and (ii) interactions detected by the plurality of end user computing devices within a second amount of time after the receipt of the first content item.

8. The system of claim 1, wherein to access the client data, the data processing system comprises the one or more processors, coupled with the memory, to:
authorize based on the request, access to a data repository that securely stores client data;
provide the client data to the secure environment to execute the data analysis process.

9. The system of claim 1, wherein the data processing system comprises the one or more processors, coupled with the memory to:
determine a first resource allocation schema to allocate resources to the plurality of end user computing devices, wherein the first content item is selected based on the first resource allocation schema;
generate a second resource allocation schema comprising an updated allocation of the resources to the plurality of end user computing devices based on the performance score.

10. The system of claim 1, wherein the data processing system comprises the one or more processors, coupled with the memory to:
generate the data processing model based on input received from the client computing device and the first content item.

11. The system of claim 1, wherein each end user computing device of the plurality of end user computing devices is selected from a corpus of candidate end user computing devices based on end user information associated with each candidate end user computing device, wherein the first content item is selected based on the end user information associated with each candidate end user computing device.

12. The system of claim 1, wherein the data processing system comprises the one or more processors, coupled with the memory to:
deploy a client application comprising software to implement the data processing model, the client application instantiating the secure environment.

13. The system of claim 1, wherein the data processing system comprises the one or more processors, coupled with the memory to:
execute an encryption process to the transformed client data and the data mapping to generate encrypted client data and an encrypted data mapping;
provide the encrypted client data and the encrypted data mapping to the computing device external to the secure environment to determine the performance score, wherein the performance score being received comprises:
receive an encrypted performance score, and
decrypt the encrypted performance score using a decryption process to obtain the performance score.

14. A method, implemented by one or more processors of a computing device, comprising:
receiving, from a client computing device, a request to execute a data analysis process to measure an effectiveness of a first content item on a plurality of end user computing devices;
accessing client data comprising, for each of the plurality of end user computing devices, interaction data representing interactions with the first content item;
executing, using the client data, a data processing model in a secure environment to obtain (i) transformed client data structured in accordance with a predefined format and (ii) a data mapping of one or more data fields from the client data to input data;
receiving, from a computing device external to the secure environment, a performance score representing the effectiveness of the first content item based on (i) the transformed client data structured in accordance with the predefined format and (ii) the data mapping of the one or more data fields from the client data to the input data; and
selecting a second content item based on the performance score.

15. The method of claim 14, comprising:
providing, to the computing device external to the secure environment, (i) the transformed client data structured in accordance with the predefined format and (ii) the data mapping of the one or more data fields from the client data to the input data.

16.-18. (canceled)

19. The method of claim 14, comprising:
providing the second content item to at least a subset of the plurality of end user computing devices.

20. (canceled)

21. The method of claim 14, wherein accessing the client data comprises:
authorizing based on the request, access to a data repository that securely stores client data; and
providing the client data to the secure environment to execute the data analysis process.

22. The method of claim 14, comprising:
determining a first resource allocation schema to allocate resources to the plurality of end user computing devices, wherein the first content item is selected based on the first resource allocation schema; and
generating a second resource allocation schema comprising an updated allocation of the resources to the plurality of end user computing devices based on the performance score.

23. The method of claim 14, comprising:
generating the data processing model based on input received from the client computing device and the first content item.

24.-27. (canceled)

28. One or more non-transitory computer-readable media storing computer program instructions that, when executed by one or more processors, effectuate operations comprising:
receiving, from a client computing device, a request to execute a data analysis process to measure an effectiveness of a first content item on a plurality of end user computing devices;
accessing client data comprising, for each of the plurality of end user computing devices, interaction data representing interactions with the first content item;
executing, using the client data, a data processing model in a secure environment to obtain (i) transformed client data structured in accordance with a predefined format and (ii) a data mapping of one or more data fields from the client data to input data;
receiving, from a computing device external to the secure environment, a performance score representing the effectiveness of the first content item based on (i) the transformed client data structured in accordance with the predefined format and (ii) the data mapping of the one or more data fields from the client data to the input data; and
selecting a second content item based on the performance score.

29.-41. (canceled)
